(19) United States
(12) Patent Application Publication
(10) Pub. No.: US 2016/0019533 A1
(43) Pub. Date: Jan. 21, 2016

(54) METHOD AND SYSTEM FOR FACILITATING AUTHORIZATION OF A TRANSACTION

(71) Applicant: MasterCard Asia Pacific Pte. Ltd., Singapore (SG)

(72) Inventors: Wilianto Wu, Singapore (SG); Vijin Venugopalan, Singapore (SG)

(21) Appl. No.: 14/751,569

(22) Filed: Jun. 26, 2015

(30) Foreign Application Priority Data
Jul. 16, 2014 (SG) 10201404137X

(51) Int. Cl. G06Q 20/36; G06Q 20/20; G06Q 20/32; G06Q 20/40; G06Q 20/38

(52) U.S. Cl. CPC G06Q 20/3674; G06Q 20/405; G06Q 20/385; G06Q 20/401; G06Q 20/3829; G06Q 20/3224; G06Q 20/3278; G06Q 20/202

(57) ABSTRACT

Method and system for facilitating authorization of a transaction. The method comprises: generating a unique identifier for each the transaction, the unique identifier being generated at a server; providing transaction details to a mobile electronic device via the server, the transaction details associated with each the transaction and being provided after receipt of the generated unique identifier; and generating, at the mobile electronic device, a cryptogram, based on the unique identifier and the transaction details, for facilitating authorization of each the transaction. The system comprises server(s), point-of-sale terminal(s) and mobile electronic devices.

### CROSS-REFERENCE TO RELATED APPLICATION

This application is a U.S. National Stage filing under 35 U.S.C. §119, based on and claiming benefit of and priority to SG Patent Application No. 10201404137X filed Jul. 16, 2014.

### TECHNICAL FIELD OF INVENTION

The following discloses a method and system for facilitating authorization of a transaction. The system comprises server(s), point-of-sale terminal(s) and mobile electronic devices.

### BACKGROUND

“One-pass payment transactions” (where consumers only pass a single piece of transaction information to the merchant) are usually done in a “Card Not Present” environment, where there is no proof of transaction available to the merchant. An example is an electronic online payment transaction. This results in a higher possibility of fraud and the merchant faces difficulty protecting itself against charge-back requests from consumers.

Non-repudiation solutions exist. Currently, non-repudiation cashless payment transactions in proximity payment schemes (i.e. face-to-face transactions) are usually performed using a predefined secure protocol. This means that the transaction involves multiple round-trip communication flows between a consumer device (operating a mobile wallet application) and an acceptance terminal (for card and terminal authentication, and payment authorization). The secure protocol results in a complex implementation (e.g. use of a session key, etc) on both the consumer device and the acceptance terminal as there is a need to certify all elements (hardware and software) involved in the payment transaction.

A need therefore exists to provide method(s) and system(s) for facilitating authorization of a transaction that seeks to address at least the above-mentioned problems.

### SUMMARY

According to one aspect of the invention, there is provided a method for facilitating authorization of a transaction, the method comprising: generating a unique identifier for the transaction, the unique identifier being generated at a server; providing transaction details to a mobile electronic device via the server, the transaction details associated with the transaction and being provided after receipt of the generated unique identifier; and generating, at the mobile electronic device, a cryptogram, based on the unique identifier and the transaction details, for facilitating authorization of the transaction.

In an embodiment, the method may further comprise providing the generated unique identifier together with the transaction details to the mobile electronic device for generation of the cryptogram.

In an embodiment, the method may further comprise configuring any one or more of the unique identifier, the transaction details and the cryptogram to be valid only for a certain period of time.

In an embodiment, the method may further comprise verifying the authenticity of the cryptogram, wherein the transaction is authorised based on the result of the verification.

In an embodiment, the method may further comprise generating a payment transaction confirmation upon successful authorization of the transaction.

In an embodiment, the method may further comprise generating the cryptogram using a payment credential secret key.

In an embodiment, the transaction may be a payment performed at a physical store.

In an embodiment, the transaction details may comprise one or more of: transaction cost, currency, merchant ID, date/time of transaction.

According to another aspect of the invention, there is provided a server in communication with a point-of-sale terminal and a device that initiates a transaction with the point-of-sale terminal, the server comprising: at least one processor; and at least one memory including computer program code; the at least one memory and the computer program code configured to, with the at least one processor, cause the server at least to: generate a unique identifier for the transaction; receive, from the point-of-sale terminal, transaction details associated with the transaction and the unique identifier; and transmit the unique identifier and the transaction details to the device for the device to generate a cryptogram, based on the unique identifier and the transaction details, for facilitating authorization of the transaction.

In an embodiment, the server may be further caused to configure the unique identifier to be valid only for a certain period of time.

In an embodiment, the server may be further caused to verify the authenticity of the cryptogram, wherein the transaction is authorised based on the result of the verification.

In an embodiment, the server may be further caused to generate a payment transaction confirmation upon successful authorization of the transaction.

According to another aspect of the invention, there is provided a point-of-sale terminal in communication with a server and a device that initiates a transaction with the point-of-sale terminal, the point-of-sale terminal comprising: at least one transceiver; at least one processor; and at least one memory including computer program code; the at least one memory and the computer program code configured to, with the at least one processor, cause the point-of-sale terminal at least to: activate the transceiver to receive, from the device, a unique identifier that is generated by the server for the transaction; provide transaction details associated with the transaction; and transmit, to the server, the unique identifier and the transaction details for the device to subsequently generate a cryptogram, based on the unique identifier and the transaction details, for facilitating authorization of the transaction.

In an embodiment, the point-of-sale terminal may further comprise an image capturing module, the image capturing module adapted to capture a visual representation of the unique identifier displayed on the device.

In an embodiment, the visual representation of the unique identifier may comprise one or more of a QR code or bar code.

In an embodiment, the at least one transceiver may be configured to receive the unique identifier from the device via a proximity communication protocol. The proximity communication protocol may comprise one or more of: Bluetooth, Wi-fi direct, Near Field Communication (NFC).

According to another aspect of the invention, there is provided a device in communication with a server and a point-of-sale terminal, the device configured to initiate a transaction with the point-of-sale terminal, the device comprising: at least one transceiver; at least one processor; and at least one memory including computer program code; the at least one memory and the computer program code configured to, with the at least one processor, cause the device at least to: activate the transceiver to request the server to generate a unique identifier for the transaction and receive the generated unique identifier; transmit, to the point-of-sale terminal, the unique identifier generated by the server; receive, from the server, the unique identifier and transaction details associated with the transaction, wherein the server receives the transaction details from the point-of-sale sale terminal; and generate a cryptogram, based on the unique identifier and the transaction details, for facilitating authorization of the transaction.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 is a schematic of a system in which authorization of a transaction may be performed;

FIG. 2 is a schematic of another system in which authorization of a transaction may be performed;

FIG. 3 shows an exemplary computing device to realize a server for the remote terminal and/or the remote hub shown in FIGS. 1 and 2.

FIG. 4 shows a flowchart depicting steps of a method for facilitating authorization of a transaction.

FIG. 5 shows a schematic of a server to realize a remote terminal and/or a remote hub.

FIG. 6 is a schematic of an exemplary wireless computing device to implement a point-of-sale terminal and/or a mobile electronic device.

### DETAILED DESCRIPTION

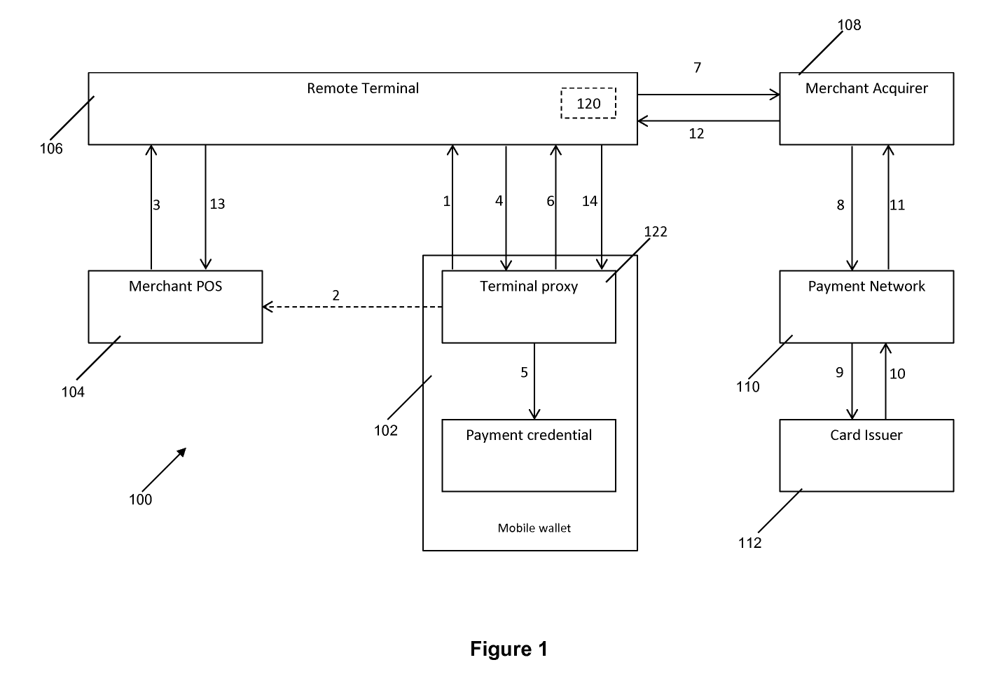

FIG. 1 is a schematic of a system 100 in which authorization of a transaction may be performed. Here, transactions include, but are not limited to, electronic payment transactions using credit/debit cards performed at a physical store. The system 100 comprises a mobile electronic device 102 (e.g. smart phone, tablet computer), a point-of-sale terminal 104, a remote terminal 106, a merchant acquirer 108, a payment network 110 and a card issuer 112. The mobile electronic device 102 is in communication with the remote terminal 106, e.g. via an Internet connection. The point-of-sale terminal 104 is in communication with the remote terminal 106, e.g. via an Internet connection. The remote terminal 106 is in communication with the merchant acquirer 108. The payment network 110 is in communication with both the merchant acquirer 108 and the card issuer 112. The various arrows in FIG. 1 represent access flows between the various components and entities in the system 100. For simplicity, the components in the system 100 are represented by single units (e.g. one mobile electronic device 102, one point-of-sale (POS) terminal 104, one remote terminal 106, etc). However, it will be appreciated by a person skilled in the art that the system 100 can accommodate more than unit of each component (e.g. a plurality of mobile electronic devices and/or point-of-sale terminals).

The merchant acquirer 108 primarily processes credit and/or debit card payments for goods or services for merchants. The card issuer 112 primarily provides payment instruments, such as a credit or a debit card, for holders (i.e. consumers) of such instruments to make purchases from the merchant. The card issuer 112 typically provides the owner of such payment instruments a credit line (especially in the case of the credit card) against which is checked whether there are sufficient funds to pay for a transaction initiated by the holder of a payment instrument. In this context, the card issuer 112 can be understood to be the bank of the consumer. The payment network 110 may be administered by a payment facilitator (e.g. MasterCard®), who facilitates payments between the entities (e.g. an acquiring bank and an issuing bank) in the system 100.

Although the system 100 can accommodate multiple consumers, for the sake of brevity, the following description relates to one consumer initiating a transaction with a merchant.

A mobile wallet application is installed on the mobile electronic device 102. When a consumer wishes to initiate a transaction, he uses the mobile wallet application to obtain an identifier for the transaction. The identifier is unique to each and every transaction. The mobile electronic device 102 sends a request for this unique identifier (arrow 1) to the remote terminal 106. The remote terminal 106 generates the unique identifier to the transaction. That is, if the consumer subsequently initiates another transaction, a different identifier is generated. A database 120 at the remote terminal 106 may store the unique identifier.

Upon receipt of the unique identifier from the remote terminal 106, the consumer is then able to proceed with his desired transaction. The consumer uses his mobile electronic device 102 to pass the unique identifier to the point-of-sale terminal 104 through the mobile electronic device's terminal proxy (arrow 2). For example, the unique identifier can be passed to the point-of-sale terminal 104 via a proximity communication protocol/channel (e.g. QR code, bar code, Bluetooth, Infrared (IrDA), Wi-fi Direct, contactless Near Field Communication (NFC)). The unique identifier may be valid for a pre-determined period of time (e.g. 30 seconds). After this period, the unique identifier is no longer valid. Having a time-out period advantageously enhances security. For example, if a QR code is used to represent the unique identifier, the consumer has to present the QR code to the point-of-sale terminal 104 for scanning within the pre-determined period of time. This prevents malicious use where a copy of the QR code is surreptitiously taken and subsequently used by an unauthorized party. The point-of-sale terminal 104 receives the unique identifier from the mobile electronic device 102. From the consumer performing the transaction using the unique identifier, the point-of-sale terminal 104 has transaction details which include one or more of: transaction cost/dollar amount, currency, merchant ID, date/time of transaction. The point-of-sale terminal 104 passes the unique identifier and transaction details to the remote terminal 106 (arrow 3). In an example implementation, the unique identifier and the transaction details are passed as separate data packets or a single data packet where the unique identifier and the transaction details are appended to each other, i.e. one does not modify the other.

The remote terminal 106 stores the received transaction details in the database 120, in addition to the previously stored unique identifier. The remote terminal 106 also passes the received unique identifier and transaction details to the mobile electronic device 102 (arrow 4).

A terminal proxy 122 of the mobile electronic device 102 receives the unique identifier and transaction details. An EMV (described in further detail in the subsequent paragraph) transaction request is initiated (arrow 5) and the mobile wallet application generates a cryptogram that is based on the unique identifier and the transaction details. In an example implementation, the cryptogram may only be generated with a valid unique identifier (the unique identifier is received within the pre-determined period of time and has not timed-out). The cryptogram is used for facilitating authorization of the transaction and may be computed using a payment credential secret key that is stored in a secure element in the mobile electronic device 102 (e.g. SIM card, removable storage card (e.g. SD card, memory module). In this manner, the cryptogram acts as a proof of the transaction.

The EMV transaction process may refer to a global standard for allowing inter-operation of integrated circuit cards (IC cards or “chip cards”) and IC card capable point of sale (POS) terminals and automated teller machines (ATMs) for authenticating credit and debit card transactions from Europay™, MasterCard™ and Visa™. The EMV transaction process generally involves an Authorization Request Cryptogram (ARQC) and an Authorization Response Cryptogram (ARPC). The ARQC is generated by the credit/debit card after taking required values from the POS terminal and is part of a request message. The ARQC is sent to an issuer authorization system for verification. Thereafter, the ARPC is generated by the issuer and is part of a response message. The ARPC is sent to the POS terminal.

The mobile electronic device 102 passes the cryptogram to the remote terminal 106 (arrow 6). The remote terminal 106 stores the received cryptogram in the database 120 in addition to the previously stored unique identifier and transaction details.

The remote terminal 106 passes the cryptogram to the merchant acquirer 108 (arrow 7). The merchant acquirer 108 then passes the cryptogram to the payment network 110 (arrow 8). Thereafter, the payment network 110 passes the cryptogram to the card issuer 112 (arrow 9).

The card issuer 112 verifies the cryptogram and sends the authorization result to the payment network 110 (arrow 10). The payment network 110 then sends the authorization result to the merchant acquirer 108 (arrow 11). Thereafter, the merchant acquirer 108 sends the authorization result to the remote terminal 106 (arrow 12).

The remote terminal 106 stores the received authorization result in the database 120, in addition to the previously stored cryptogram, unique identifier and transaction details. In an example implementation, information is stored in the database at a transaction level. Each transaction is associated with its unique identifier, transaction details, cryptogram and authorization result.

Assuming that the authorization result is positive, the remote terminal 106 sends a payment transaction confirmation to the point-of-sale terminal 104 (arrow 13). At around the same time, the remote terminal 106 sends a payment transaction confirmation to the mobile electronic device 102 (arrow 14).

In an example implementation, the point-of-sale terminal 104 may be adapted to accept the unique identifier via any communication medium as long as the merchant can capture the unique identifier and the mobile electronic device 102 can receive the appended transaction details within a designated time-period (time-out). For example, besides the communication channels described above (QR code, bar code, Bluetooth, IrDA, Wi-fi Direct, NFC), manual entry may also be possible. Manual entry may involve the following steps:

Step 1: A consumer shows the unique identifier to a merchant.

Step 2: The merchant manually enters the unique identifier into the point-of-sale terminal 104.

Step 3: The consumer's mobile electronic device 102 is triggered by the remote terminal 106 to prompt for an input of a personal identification number (PIN) by the consumer.

Step 4: After entering the PIN in the mobile electronic device 102, the terminal proxy executes the EMV process and sends the cryptogram to the remote terminal 106.

The system 100 is a closed-loop system and is suitable for a single merchant environment. The single merchant administers the point-of-sale terminal 104 and the remote terminal 106. The remote terminal 106 acts as a relay for the received transaction details, cryptogram and authorization result. The remote terminal 106 also acts as a relay for the unique identifier that the remote terminal 106 generates, which is returned to the remote terminal 106 during the process of authorizing the transaction. With the unique identifier featuring at stages (such as the providing of the transaction details at the point-of-sale terminal 104 and the generation of the cryptogram at the mobile electronic device 102) that triggers further information to be included into the data packet that leads to completion of the transaction, the unique identifier acts as a piece of transaction initiation information that is commonly passed between the various components and entities in the system 100 which is required to complete the transaction.

The Remote Terminal 106 can also be configured as a transaction controller to check the validity of the transaction details coming from the point-of-sale terminal 104. In an examplary implementation, the Remote Terminal 106 can also be configured to check the time-out parameters. For a first time-out parameter, the transaction may be rejected if the transaction details and/or unique identifier from the point-of-sale terminal 104 come after the time-out. On the mobile application side, the Remote Terminal 106 can also be configured to manage a second time-out parameter from the time when the unique identifier and transaction details are passed to the mobile wallet application to the time the mobile wallet application returns the cryptogram to the Remote Terminal 106. That is, the unique identifier, the transaction details and the cryptogram may be configured to be valid only for a certain period of time.

The mobile wallet application is only usable with the single merchant as the mobile wallet application is integrated with that merchant's remote terminal. Of course, one merchant can have multiple store outlets and multiple point-of-sale terminals. Also, more than one consumer may be conducting a transaction with the merchant using the system 100 at any single point in time.

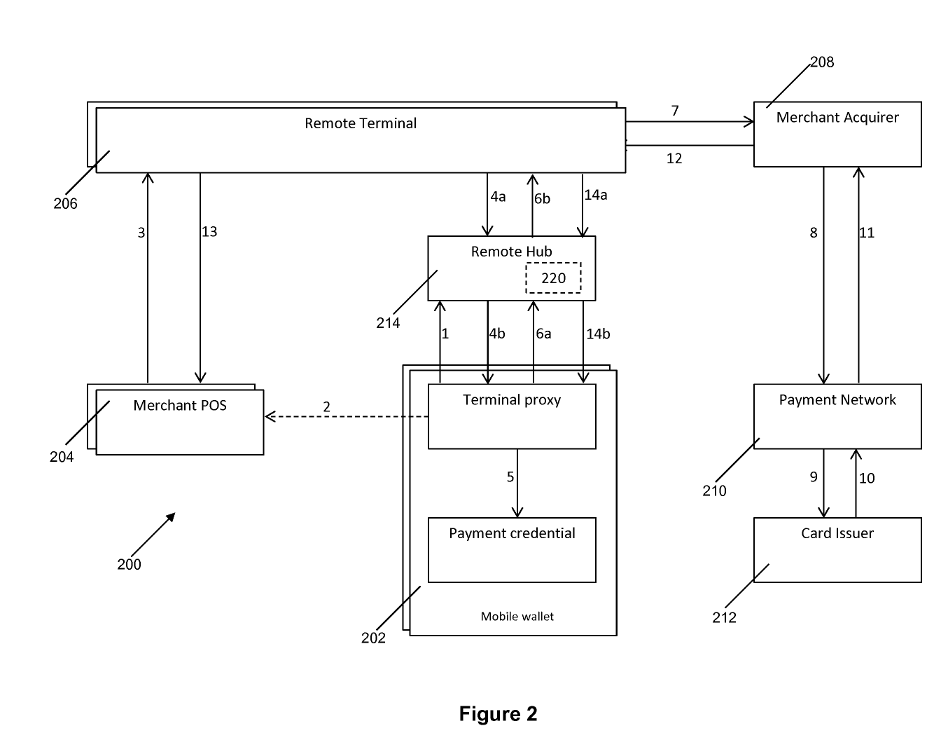

FIG. 2 is a schematic of a system 200 in which authorization of a transaction may be performed. The system 200 is similar to system 100, the difference being that the system 200 is an open-loop system and is suitable for a multiple merchant environment. That is, system 200 is an interoperable system where consumers can transact with multiple merchants. In addition, the system 200 has a remote hub 214 that acts as an interface between remote terminals 206 and mobile electronic devices 202. The remote hub 214 resolves interfacing issues, i.e. allows communication of data between the multiple remote terminals 106 and the multiple mobile electronic devices 202, even though each may be operating incompatible operating systems. The various arrows in FIG. 2 represent access flows between the various components and entities in the system.

The system 200 comprises mobile electronic devices 202 (e.g. smart phones, tablet computers), point-of-sale terminals 204, remote terminals 206, a merchant acquirer 208, a payment network 210, a card issuer 212 and a remote hub 214. The mobile electronic devices 202 are in communication with the remote terminals 206 via the remote hub 214. The remote hub 214 may be in communication with both the mobile electronic devices 202 and remote terminals 206, e.g. via an Internet connection. The point-of-sale terminals 204 are in communication with the remote terminals 206, e.g. via an Internet connection. The remote terminals 206 are in communication with the merchant acquirer 208. The payment network 210 is in communication with both the merchant acquirer 208 and the card issuer 212. Each participating merchant administers its point-of-sale terminal(s) 204 and remote terminal 206. In one embodiment, the remote hub 214 may be administered by the payment network facilitator, although in other embodiments, a third party may administer the remote hub 214. The remote hub 214 facilitates the participation of multiple merchants.

Although the system 200 can accommodate multiple merchants and multiple consumers, for the sake of brevity, the following description relates to one consumer initiating a transaction with a single merchant.

A mobile wallet application is installed on the mobile electronic device 202. When the consumer wishes to initiate a transaction, he uses the mobile wallet application to obtain an identifier for the transaction. The identifier is unique to each and every transaction. The mobile electronic device 202 sends a request for this unique identifier (arrow 1) to the remote hub 214. The remote hub 214 generates the unique identifier to the transaction. A database 220 at the remote hub 214 stores the unique identifier. The Remote Hub 214 may have a global database for transactions worldwide. In contrast, the remote terminal 106 described above has a local database for merchant specific transactions.

The mobile wallet application may be provided by any service provider and can be used with any participating merchant. In other words, no specific integration is required between the mobile wallet application and the individual merchants. However, each mobile wallet application is integrated with the centralized remote hub. The system 200 allows a consumer to conduct a transaction in any country (with any participating merchant) as long as the consumer is connected to the centralized remote hub.

Upon receipt of the unique identifier from the remote hub 214, the consumer uses his mobile electronic device 202 to pass the unique identifier to the point-of-sale terminal 204 through the mobile electronic device's terminal proxy (arrow 2). For example, the unique identifier can be passed to the point-of-sale terminal 204 via a proximity communication protocol/channel (e.g. QR code, bar code, Bluetooth, Infrared (IrDA), Wi-fi Direct, Near Field Communication (NFC)). The unique identifier may be valid for a pre-determined period of time (e.g. 30 seconds). After this period, the unique identifier is no longer valid. Having a time-out period advantageously enhances security. For example, if a QR code is used to represent the unique identifier, the consumer has to present the QR code to the point-of-sale terminal 204 for scanning within the pre-determined period of time. This is to prevent malicious use where a copy of the QR code is surreptitiously taken and subsequently used by an unauthorized party.

The point-of-sale terminal 204 receives the unique identifier from the mobile electronic device 202 and passes the unique identifier and transaction details to the appropriate remote terminal 206 (arrow 3). The appropriate remote terminal 206 is one that is associated and administered by the merchant whom the consumer is transacting with. The transaction details are generated by the point-of-sale terminal and associated with the transaction. The transaction details include one or more of: transaction cost/dollar amount, currency, merchant ID, date/time of transaction.

The remote terminal 206 passes the received unique identifier and transaction details to the mobile electronic device 202 via the remote hub 214 (arrows 4a and 4b). The remote hub 214 stores the received transaction details in the database 220, in addition to the previously stored unique identifier.

The terminal proxy of the mobile electronic device 202 receives the unique identifier and transaction details. An EMV transaction request is initiated (arrow 5) and the mobile wallet generates a cryptogram that is based on the unique identifier and the transaction details. In an example implementation, the cryptogram may only be generated with a valid unique identifier (the unique identifier is received within the pre-determined period of time and has not timed-out). The cryptogram is used for facilitating authorization of the transaction and may be computed using a payment credential secret key that is stored in a secure element in the mobile electronic device 102 (e.g. SIM card, removable storage card (e.g. SD card), memory module). In this manner, the cryptogram acts as a proof of the transaction. The payment credential may be an application that has the capability to perform secure transaction protocols (e.g. EMV protocol).

The mobile electronic device 202 passes the cryptogram to the remote terminal 206 via the remote hub 214 (arrow 6a and 6b). The remote hub 214 stores the received cryptogram, in addition to the previously stored unique identifier and transaction details, in the database 220.

The remote terminal 206 passes the cryptogram to the merchant acquirer 208 (arrow 7). The merchant acquirer 208 then passes the cryptogram to the payment network 210 (arrow 8). Thereafter, the payment network 210 passes the cryptogram to the card issuer 212 (arrow 9).

The card issuer 212 verifies the cryptogram and sends the authorization result to the payment network 210 (arrow 10). The payment network 210 then sends the authorization result to the merchant acquirer 208 (arrow 11). Thereafter, the merchant acquirer 208 sends the authorization result to the remote terminal 206 (arrow 12).

Assuming that the authorization result is positive, the remote terminal 206 sends a payment transaction confirmation to the point-of-sale terminal 204 (arrow 13). At around the same time, the remote terminal 206 sends a payment transaction confirmation to the mobile electronic device 202 via the remote hub 214 (arrows 14a and 14b). The remote hub 214 stores the received authorization result in the database, in addition to the previously stored cryptogram, unique identifier and transaction details.

The remote terminal 106/206 and/or the remote hub 214 can be implemented using a server. The server may be a dedicated physical server or a cloud server. Use of the term ‘server’ herein may be understood to mean a single computing device or a plurality of interconnected computing devices which operate together to perform a particular function. That is, the server may be contained within a single hardware unit or be distributed among several or many different hardware units.

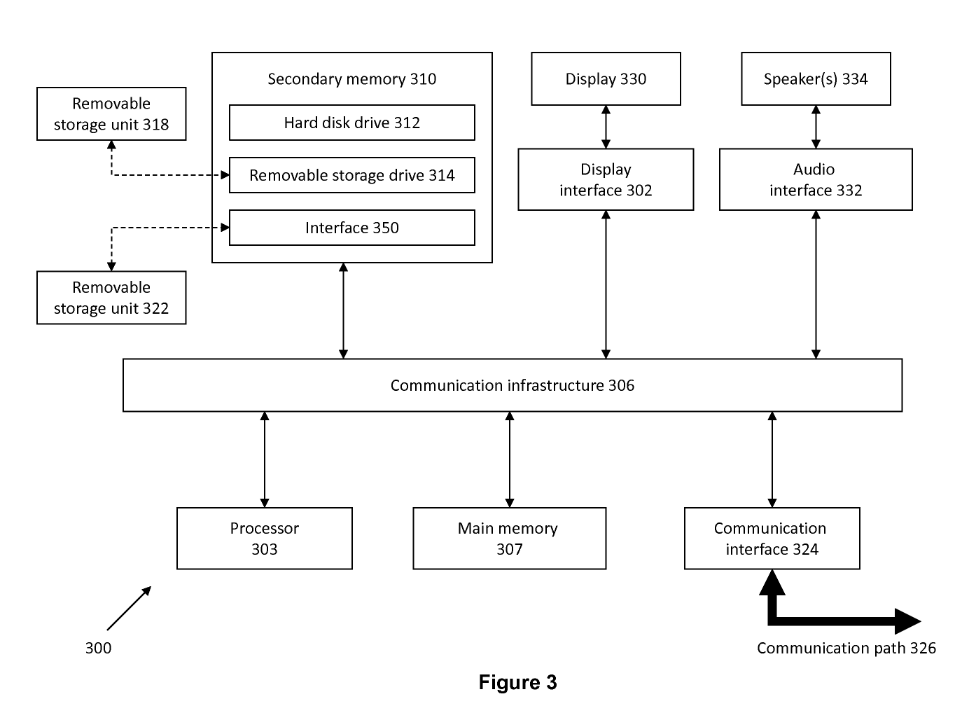

FIG. 3 shows an exemplary computing device 300, to realize a server that functions as the remote terminal 106/206 and/or the remote hub 214 shown in FIGS. 1 and 2. The following description of the computing device 300 is provided by way of example only and is not intended to be limiting. Therefore, one or more elements/components of the computing device 300 may be omitted. Also, one or more elements/components of the computing device 300 may be combined together. Additionally, one or more elements/components of the computing device 300 may be split into one or more component parts.

With reference to FIG. 3, the exemplary computing device 300 includes a processor 303 for executing software routines. Although a single processor is shown for the sake of clarity, the computing device 300 may also include a multi-processor system. The processor 303 is connected to a communication infrastructure 306 for communication with other components of the computing device 300. The communication infrastructure 306 may include, for example, a communications bus, cross-bar, or network.

The computing device 300 further includes a main memory 307, such as a random access memory (RAM), and a secondary memory 310. The secondary memory 310 may include, for example, a hard disk drive 312 and/or a removable storage drive 314, which may include a magnetic tape drive, an optical disk drive, or the like. The removable storage drive 314 reads from and/or writes to a removable storage unit 318 in a well-known manner. The removable storage unit 318 may include a magnetic disk, optical disk, or the like, which is read by and written to by removable storage drive 314. As will be appreciated by persons skilled in the relevant art(s), the removable storage unit 318 includes a computer readable storage medium having stored therein computer executable program code instructions and/or data.

In an alternative implementation, the secondary memory 310 may additionally or alternatively include other similar means for allowing computer programs or other instructions to be loaded into the computing device 300. Such means can include, for example, a removable storage unit 322 and an interface 350. Examples of a removable storage unit 322 and interface 350 include a program cartridge and cartridge interface, a removable memory chip (such as an EPROM or PROM) and associated socket, and other removable storage units 322 and interfaces 350 which allow software and data to be transferred from the removable storage unit 322 to the computing device 300.

The computing device 300 also includes at least one communication interface 324. The communication interface 324 allows software and data to be transferred between computing device 300 and external devices via a communication path 326. In various implementations, the communication interface 324 permits data to be transferred between the computing device 300 and a data communication network, such as a public data or private data communication network. The communication interface 324 may be used to exchange data between different computing devices 300 which such computing devices 300 form part an interconnected computer network. Examples of a communication interface 324 can include a modem, a network interface (such as an Ethernet card), a communication port, an antenna with associated circuitry and the like. The communication interface 324 may be wired or may be wireless. Software and data transferred via the communication interface 324 are in the form of signals which can be electronic, electromagnetic, optical or other signals capable of being received by communication interface 324. These signals are provided to the communication interface via the communication path 326.

As shown in FIG. 3, the computing device 300 further includes a display interface 302 which performs operations for rendering images to an associated display 330 and an audio interface 332 for performing operations for playing audio content via associated speaker(s) 334.

As used herein, the term “computer program product” may refer, in part, to removable storage unit 318, removable storage unit 322, a hard disk installed in hard disk drive 312, or a carrier wave carrying software over communication path 326 (wireless link or cable) to communication interface 324. A computer readable medium can include magnetic media, optical media, or other recordable media, or media that transmits a carrier wave or other signal. These computer program products are devices for providing software to the computing device 300. Computer readable storage medium refers to any non-transitory tangible storage medium that provides recorded instructions and/or data to the computing device 300 for execution and/or processing. Examples of such storage media include floppy disks, magnetic tape, CD-ROM, DVD, Blu-ray Disc™, a hard disk drive, a ROM or integrated circuit, USB memory, a magneto-optical disk, or a computer readable card such as a PCMCIA card and the like, whether or not such devices are internal or external of the computing device 300. Examples of transitory or non-tangible computer readable transmission media that may also participate in the provision of software, application programs, instructions and/or data to the computing device 300 include radio or infra-red transmission channels as well as a network connection to another computer or networked device, and the Internet or Intranets including e-mail transmissions and information recorded on Websites and the like.

The computer programs (also called computer program code) are stored in main memory 307 and/or secondary memory 310. Computer programs can also be received via the communication interface 324. Such computer programs, when executed, enable the computing device 300 to perform one or more steps that facilitate the authorization of transactions, as described above with reference to FIGS. 1 and 2. The computer programs, when executed, enable the processor 303 to facilitate the authorization of transactions. Accordingly, such computer programs may represent controllers of the computing device 300.

Software may be stored in a computer program product and loaded into the computing device 300 using the removable storage drive 314, the hard disk drive 312, or the interface 350. Alternatively, the computer program product may be downloaded to the computing device 300 over the communications path 326. The software, when executed by the processor 303, causes the computing device 300 to perform the necessary operations to execute one or more steps that facilitate the authorization of transactions, as described above with reference to FIGS. 1 and 2.

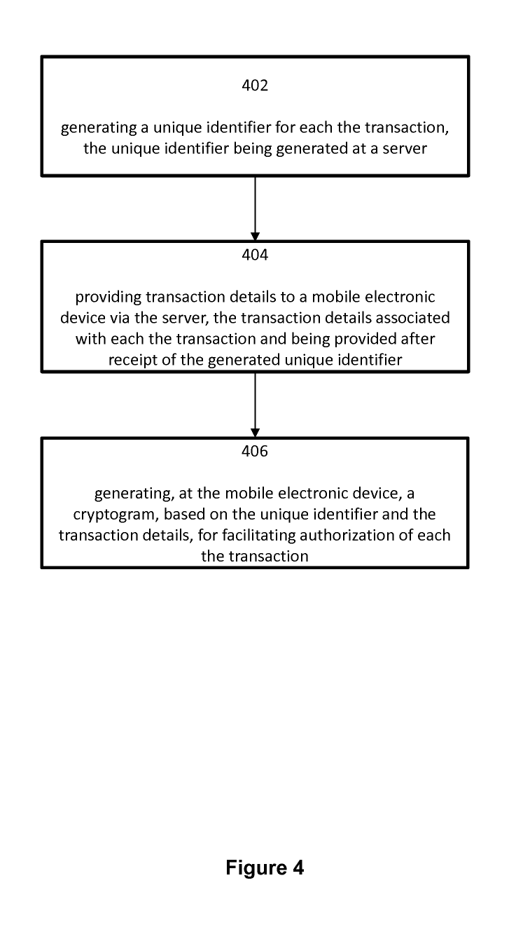

FIG. 4 shows a flowchart depicting steps of a method that allows the system 100 and 200 in accordance with FIGS. 1 and 2 to facilitate the authorization of transactions. The method includes the following steps as detailed below and described with reference to FIGS. 1 and 2.

In step 402, a unique identifier is generated for each transaction by the remote terminal 106 or remote hub 206. As mentioned above, the remote terminal 106 and/or remote hub 206 may be implemented as a server. The identifier is unique to each and every transaction. That is, if the consumer subsequently initiates another transaction, a different identifier is obtained.

After step 402, the unique identifier may be passed to the point-of-sale terminal 104/204 via a proximity communication protocol/channel (e.g. QR code, bar code, Bluetooth, Infrared (IrDA), Wi-fi Direct, contactless Near Field Communication (NFC)). In the case of the QR code, the unique identifier may be represented by the QR code. A mobile wallet application installed on the consumer's mobile electronic device 102/202 displays the QR code. A QR code scanner in communication with the point-of-sale terminal 104/204 scans the QR code in order to obtain the unique identifier from the consumer. The consumer only passes one piece of information (i.e. the unique identifier) to the merchant. This may be known as a “one-pass” payment transaction. There is no dialogue (i.e. two-way exchange of data/information) between the consumer and merchant. The unique identifier may be valid for a pre-determined period of time (e.g. 30 seconds). After this period, the unique identifier is longer valid. Having a time-out period advantageously enhances security. For example, if a QR code is used to represent the unique identifier, the consumer has to pass the QR code to the point-of-sale terminal 104 within the pre-determined period of time. This is to prevent malicious use where a copy of the QR code is surreptitiously taken and subsequently used by an unauthorized party.

In step 404, after receipt of the generated unique identifier (in step 402), transaction details associated with each transaction are provided by the point-of-sale terminal 104/204 to the remote terminal 106/206. The remote terminal 106/206 in turn provides the transaction details to the mobile electronic device 102/202 (e.g. directly or via a remote hub 214). The transaction details are generated by the point-of-sale terminal 104/204 and are associated with the transaction. The transaction details include one or more of:

transaction cost/dollar amount, currency, merchant ID, date/time of transaction. In addition to the transaction details, the unique identifier may also be provided by the point-of-sale terminal 104/204 to the remote terminal 106/206.

In step 406, a cryptogram is generated by the mobile wallet application installed on the mobile electronic device 102/202. The cryptogram is based on the unique identifier (generated from step 402) and the transaction details (provided from step 404). In addition to the transaction details, the unique identifier may be provided by the remote terminal 106/206 to the mobile electronic device 102/202 (e.g. directly or via a remote hub 214). In an example implementation, the cryptogram may only be generated with a valid unique identifier (the unique identifier is received within the pre-determined period of time and has not timed-out). The cryptogram is used for facilitating authorization of the transaction and may be computed using a payment credential secret key that is stored in a secure element in the mobile electronic device 102 (e.g. SIM card, removable storage card (e.g. SD card), memory module). The payment credential is an application that has the capability to perform secure transaction protocols (e.g. EMV protocol). In this manner, the cryptogram acts as a proof of the transaction (i.e. proof that the consumer initiated the transaction) which can minimize charge-back due to a consumer's repudiation.

After step 406, the method may further comprise the step of verifying the authenticity of the cryptogram. The card issuer 112 may have a suitable system to verify the cryptogram. In this manner, each transaction is authorised based on the verification step. Upon successful verification step (i.e. the transaction is authorized), a payment transaction confirmation may be generated by the remote terminal 106/206.

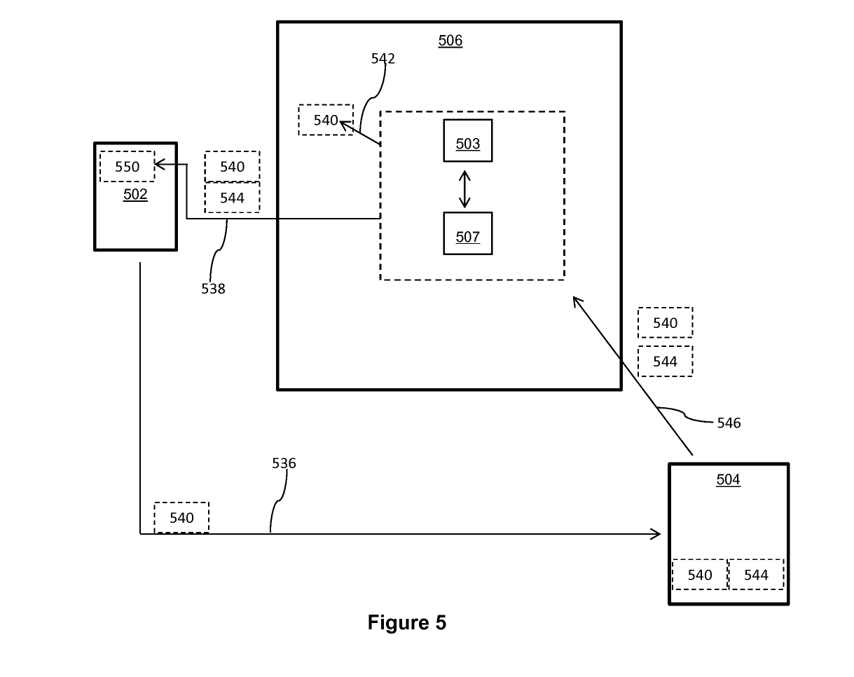

FIG. 5 shows a schematic of a server 506 to realize at least a portion of the remote terminal 106/206 and/or the remote hub 214 of the systems 100/200 shown in FIGS. 1 and 2. The server 506 facilitates authorization of a transaction and includes at least one processor 503 and at least one memory 507. Other components that the server 506 may have are omitted for the purposes of simplicity.

The server 506 is in communication with a point-of-sale terminal 504 and a mobile electronic device 502. In an example implementation, the server 506 is in communication with the point-of-sale terminal 504 and the mobile electronic device 502 via an Internet connection.

Computer program code within the at least one memory 507 is configured to have the at least one memory 507, with the at least one processor 503, cause the server 506 to: (i) generate 542 a unique identifier 540 for each transaction; (ii) receive 546, from the point-of-sale terminal 504, transaction details 544 associated with each transaction and the unique identifier 540; and/or (iii) transmit 538 the unique identifier 540 and the transaction details 544 to the mobile electronic device 502 for the mobile electronic device 502 to generate a cryptogram 550, based on the unique identifier 540 and the transaction details 544, for facilitating authorization of each transaction.

The at least one memory 507 may be capable of storing one or more of: the unique identifier 540, the cryptogram 550, the payment transaction confirmation (received after the transaction is authorized) and the transaction details 544.

The mobile electronic device 502 transmits unique identifier 540 to the point-of-sale terminal 504, e.g. via proximity communication protocols such as Wi-fi direct, Bluetooth, and NFC for the point-of-sale terminal 504 to provide the transaction details 544.

In an implementation, the server can also configure the unique identifier to be valid only for a certain period of time. The server can also verify the authenticity of the cryptogram, wherein each transaction is authorised based on the result of the verification. The server can also generate a payment transaction confirmation upon successful authorization of each transaction.

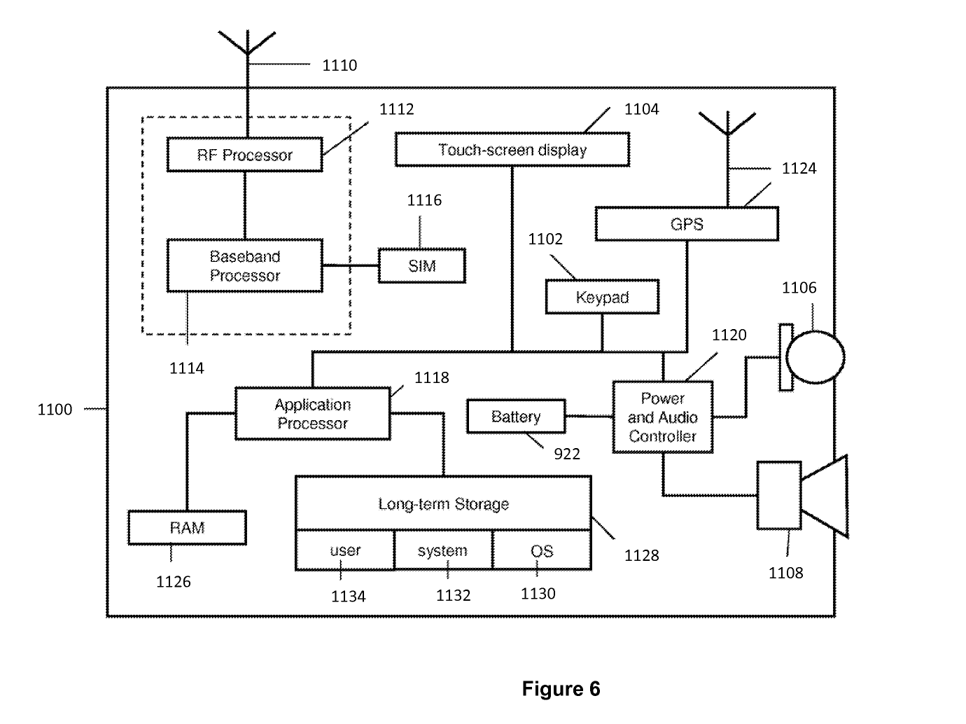

FIG. 6 is a schematic of an exemplary wireless computing device 1100 that may be utilized to implement the point-of-sale terminal 104/204 and/or a mobile electronic device 102/202 shown in FIGS. 1 and 2. The wireless device 1100 may be in communication (e.g. via an Internet connection) with another wireless device (e.g. a first wireless device acts as a point-of-sale terminal while a second wireless device acts as a mobile electronic device), the remote terminal 106/206 and/or the remote hub 214.

The wireless device 1100 comprises a keypad 1102, a touch-screen 1104, a microphone 1106, a speaker 1108 and an antenna 1110. The wireless device 1100 is capable of being operated by a user to perform a variety of different functions, such as, for example, hosting a telephone call, sending an SMS message, browsing the Internet, sending an email and providing satellite navigation.

The wireless device 1100 comprises hardware to perform communication functions (e.g. telephony, data communication), together with an application processor and corresponding support hardware to enable the wireless device 1100 to have other functions, such as, messaging, Internet browsing, email functions and the like. The communication hardware is represented by the RF processor 1112 which provides an RF signal to the antenna 1110 for the transmission of data signals, and the receipt therefrom. Additionally provided is a baseband processor 1114, which provides signals to and receives signals from the RF Processor 1112. The baseband processor 1114 also interacts with a subscriber identity module 1116, as is well known in the art. The communication subsystem enables the wireless device 1100 to communicate via a number of different communication protocols including 3G, 4G, GSM, WiFi, Wi-fi direct, Near Field Communication (NFC), Bluetooth™ and/or CDMA. The communication subsystem of the wireless device 900 is beyond the scope of the present invention.

The keypad 1102 and the touch-screen 1104 are controlled by an application processor 1118. A power and audio controller 1120 is provided to supply power from a battery 1122 to the communication subsystem, the application processor 1118, and the other hardware. The power and audio controller 1120 also controls input from the microphone 1106, and audio output via the speaker 1108. Also provided is a global positioning system (GPS) antenna and associated receiver element 1124 which is controlled by the application processor 1118 and is capable of receiving a GPS signal for use with a satellite navigation functionality of the wireless device 1100.

In order for the application processor 1118 to operate, various different types of memory are provided. Firstly, the wireless device 1100 includes Random Access Memory (RAM) 1126 connected to the application processor 1118 into which data and program code can be written and read from at will. Code placed anywhere in RAM 1126 can be executed by the application processor 1118 from the RAM 1126. RAM 1126 represents a volatile memory of the wireless device 1100.

Secondly, the wireless device 1100 is provided with a long-term storage 1128 connected to the application processor 1118. The long-term storage 1128 comprises three partitions, an operating system (OS) partition 930, a system partition 1132 and a user partition 1134. The long-term storage 1128 represents a non-volatile memory of the wireless device 1100.

In the present example, the OS partition 1130 contains the firmware of the wireless device 1100 which includes an operating system. Other computer programs may also be stored on the long-term storage 1128, such as application programs, and the like. In particular, application programs which are mandatory to the wireless device 1100, such as, in the case of a smartphone, communications applications and the like are typically stored in the system partition 1132. The application programs stored on the system partition 1132 would typically be those which are bundled with the wireless device 1100 by the device manufacturer when the wireless device 1100 is first sold.

Application programs which are added to the wireless device 1100 by the user would usually be stored in the user partition 1134.

As stated, the representation of FIG. 6 is schematic. In practice, the various functional components illustrated may be substituted into one and the same component. For example, the long-term storage 1128 may comprise NAND flash, NOR flash, a hard disk drive or a combination of these.

The wireless device 1100 may also have an image capturing module (not shown). The image capturing module, together with a suitable application, may be used to capture/scan QR codes and process the data embedded in the QR code.

If the exemplary wireless computing device 1100 is implemented as the point-of-sale terminal 104/204, the point-of-sale terminal is in communication with: (i) a server and (ii) a device that initiates a transaction with the point-of-sale terminal. The point-of-sale terminal comprises at least one transceiver (e.g. antenna 1110, RF processor 1112, Baseband processor 1114), at least one processor (e.g. application processor 1118); and at least one memory (e.g. RAM 1126, Long-term storage 1128) including computer program code; the at least one memory and the computer program code configured to, with the at least one processor, cause the point-of-sale terminal to: (i) activate the transceiver to receive, from the device, a unique identifier that is generated by the server for the transaction; (ii) generate/provide transaction details associated with the transaction; and/or (iii) transmit, to the server, the unique identifier and the transaction details for the device to subsequently generate a cryptogram, based on the unique identifier and the transaction details, for facilitating authorization of the transaction. The point-of-sale terminal may further comprise at least one transceiver that is configured to receive the unique identifier from the device via a proximity communication protocol.

If the exemplary wireless computing device 1100 is implemented as the mobile electronic device 102/202, the device is in communication with a server and a point-of-sale terminal. The device is capable of initiating a transaction with the point-of-sale terminal, and the device comprises: at least one transceiver, at least one processor; and at least one memory including computer program code; the at least one memory and the computer program code configured to, with the at least one processor, cause the device to: (i) activate the transceiver to request the server to generate a unique identifier for the transaction and receive the generated unique identifier; (ii) transmit, to the point-of-sale terminal, the unique identifier generated by the server; (iii) receive, from the server, the unique identifier and transaction details associated with the transaction, wherein the server receives the transaction details from the point-of-sale terminal; and/or (iv) generate a cryptogram, based on the unique identifier and the transaction details, for facilitating authorization of the transaction.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method for facilitating authorization of a transaction, the method comprising:
generating a unique identifier for the transaction, the unique identifier being generated at a server;
providing transaction details to a mobile electronic device via the server, the transaction details associated with the transaction and being provided after receipt of the generated unique identifier; and
generating, at the mobile electronic device, a cryptogram, based on the unique identifier and the transaction details, for facilitating authorization of the transaction.

2. The method as claimed in claim 1, further comprising providing the generated unique identifier together with the transaction details to the mobile electronic device for generation of the cryptogram.

3. The method as claimed in claim 1, further comprising configuring any one or more of the unique identifier, the transaction details and the cryptogram to be valid only for a certain period of time.

4. The method as claimed in claim 1, further comprising verifying the authenticity of the cryptogram, wherein the transaction is authorised based on the result of the verification.

5. The method as claimed in claim 4, further comprising generating a payment transaction confirmation upon successful authorization of the transaction.

6. The method as claimed in claim 1, further comprising generating the cryptogram using a payment credential secret key.

7. The method as claimed in claim 1, wherein the transaction is a payment performed at a physical store

8. The method as claimed in claim 1, wherein the transaction details comprise one or more of: transaction cost, currency, merchant ID, date/time of transaction.

9. A server in communication with a point-of-sale terminal and a device that initiates a transaction with the point-of-sale terminal, the server comprising:
at least one processor; and
at least one memory including computer program code; the at least one memory and the computer program code configured to, with the at least one processor, cause the server at least to:
generate a unique identifier for the transaction;
receive, from the point-of-sale terminal, transaction details associated with the transaction and the unique identifier; and
transmit the unique identifier and the transaction details to the device for the device to generate a cryptogram, based on the unique identifier and the transaction details, for facilitating authorization of the transaction.

10. The server as claimed in claim 9, further causing the server to configure the unique identifier to be valid only for a certain period of time.

11. The server as claimed in claim 9, further causing the server to verify the authenticity of the cryptogram, wherein the transaction is authorised based on the result of the verification.

12. The server as claimed in claim 11, further causing the server to generate a payment transaction confirmation upon successful authorization of the transaction.

13. A point-of-sale terminal in communication with a server and a device that initiates a transaction with the point-of-sale terminal, the point-of-sale terminal comprising:
at least one transceiver;
at least one processor; and
at least one memory including computer program code; the at least one memory and the computer program code configured to, with the at least one processor, cause the point-of-sale terminal at least to:
activate the transceiver to receive, from the device, a unique identifier that is generated by the server for the transaction;
provide transaction details associated with the transaction; and
transmit, to the server, the unique identifier and the transaction details for the device to subsequently generate a cryptogram, based on the unique identifier and the transaction details, for facilitating authorization of the transaction.

14. The point-of-sale terminal as claimed in claim 13, further comprising an image capturing module, the image capturing module adapted to capture a visual representation of the unique identifier displayed on the device.

15. The point-of-sale terminal as claimed in claim 14, wherein the visual representation of the unique identifier comprises one or more of a QR code or bar code.

16. The point-of-sale terminal as claimed in claim 13, wherein the at least one transceiver is configured to receive the unique identifier from the device via a proximity communication protocol.

17. The point-of-sale terminal as claimed in claim 16, wherein the proximity communication protocol comprises one or more of: Bluetooth, Wi-fi direct, Near Field Communication (NFC).

18. A device in communication with a server and a point-of-sale terminal, the device configured to initiate a transaction with the point-of-sale terminal, the device comprising:
at least one transceiver;
at least one processor; and
at least one memory including computer program code; the at least one memory and the computer program code configured to, with the at least one processor, cause the device at least to:
activate the transceiver to request the server to generate a unique identifier for the transaction and receive the generated unique identifier;
transmit, to the point-of-sale terminal, the unique identifier generated by the server;
receive, from the server, the unique identifier and transaction details associated with the transaction, wherein the server receives the transaction details from the point-of-sale terminal; and
generate a cryptogram, based on the unique identifier and the transaction details, for facilitating authorization of the transaction.
